(19) United States
(12) Patent Application Publication
(10) Pub. No.: US 2003/0043860 A1
(43) Pub. Date: Mar. 6, 2003

(54) Communication apparatus

(76) Inventors: Hideaki Miyashita, Yokohama (JP); Yasuhito Sadamoto, Yokohama (JP); Satoshi Nishimura, Yokohama (JP); Hiroaki Uno, Yokohama (JP); Akio Takayasu, Kawasaki (JP); Hideaki Koyano, Yokohama (JP)

Correspondence Address: KATTEN MUCHIN ZAVIS ROSENMAN, 575 MADISON AVENUE, NEW YORK, NY, 10022-2585, US

(21) Appl. No.: 10/105,527

(22) Filed: Mar. 25, 2002

(30) Foreign Application Priority Data
Sep. 4, 2001 (JP) 2001-267732

(51) Int. Cl. H04J 3/02

(52) U.S. Cl. 370/539

(57) ABSTRACT

A communication apparatus for interfacing various types of signals with different bit-rates is provided. The communication apparatus includes a receiving part receiving input signals, generating frames of a predetermined common format containing control information of the input signals and determining whether the frames are valid and a control part receiving the frames from the receiving part and performing a predetermined internal process based on the result of the determination.

### BACKGROUND OF THE INVENTION

1. Field of the Invention

The present invention relates to a communication apparatus and particularly relates to an asynchronous transmission apparatus for interfacing a plurality of signals with different bit-rates.

2. Description of the Related Art

An asynchronous transmission apparatus performs termination processes on control information such as destination codes or control codes of payloads contained signals transmitted over a network and, as required, transmits signals on the network with the signals being synchronized to individual clocks of the signal.

The asynchronous transmission apparatus performs a termination process on control information contained in the signals and transfers the processed control information by means of an interface that handles data in bits. Such an interface may be conform to a Stuff synchronization system.

Sonet (Synchronous Optical Network)/SDH (Synchronous Digital Hierarchy) signals are a major signals that are conventionally used in the asynchronous transmission apparatus. Recently, a Giga-bit Ethernet (Registered Trademark) and a brand new Digital Wrapper format have been standardized. Accordingly, there are a wider variety of signals transmitted over the network.

Generally, for most of the signals transmitted over the network, control information is handled as data segmented in 8 bits rather than a serial continuous data.

However, for a system in which data is handled in bits, such as the above-mentioned Stuff multiplexing system, the control information in bytes-must be decomposed into bits, transmitted to a control part and reshaped into bytes at the control part. Thus, a complicated hardware configuration is required for a large-scale apparatus.

### SUMMARY OF THE INVENTION

Accordingly, it is a general object of the present invention to provide a transmission apparatus that can obviate the problems described above.

It is another and more specific object of the present invention to provide a transmission apparatus with a simplified hardware configuration and that can be designed without being aware of a plurality of types of signals.

According to the present invention, a communication apparatus for interfacing various types of signals with different bit-rates is provide that includes:

a receiving part receiving input signals, generating frames of a predetermined common format containing control information of said input signals and determining whether said frames are valid; and

a control part receiving said frames from said receiving part and performing a predetermined internal process based on the result of the determination.

In accordance with the present invention, the frames are transferred from said receiving part to said control part in synchronous with a predetermined reference clock.

With the above-invention, various types of signals with different bit-rates are transferred in synchronous with a predetermined reference clock. Therefore, communications can be achieved without being aware of various bit-rates of the signals.

Further, in accordance with the present invention, the control part performs error detection on said frames and performs said predetermined internal process for erroneous frames.

With the above-invention, errors in the input signals can be detected at the control part and a predetermined internal process can be performed in the control part.

Further, in accordance with the present invention, the receiving part includes:

memory parts storing said control information contained in said input signals; and

assembling parts reading out said control information from said memory parts and assembling said control information into frames of a common format.

With the above-invention, the difference between various bit-rates are eliminated at the memory part.

The communication apparatus further includes a transmitting part receiving said frames from said control part, extracting said control information from said frames and transmitting output signals of different bit-rates.

With the above-invention, various types of input signals with different bit-rates can be internally processed and then various types of output signals with different bit-rates can be output.

### BRIEF DESCRIPTION OF THE DRAWINGS

FIG. 1 is a block diagram showing an asynchronous transmission apparatus of an embodiment of the present invention.

FIG. 2 is a block diagram showing an interface part of the asynchronous transmission apparatus of en embodiment of the present invention.

FIG. 3 is a diagram showing a frame of a common format.

FIG. 4 is block diagram showing a control part of the asynchronous transmission apparatus of en embodiment of the present invention.

FIG. 5 is a diagram showing a first embodiment of sending a void signal from the memory monitoring part to the control part.

FIG. 6 is a detailed block diagram of the data-link transmitting part of the interface part of a first type of a method of avoiding processing of invalid data.

FIG. 7 is a detailed block diagram of the data-link receiving part of the control part.

FIG. 8 is a timing chart showing a frame discard operation caused by VOID signals.

FIG. 9 is a detailed block diagram of the data-link transmitting part of the interface part of a second type of a method of avoiding processing of invalid data.

FIG. 10 is a detailed block diagram of the data-link transmitting part and the data-link receiving part of the interface part for a case where FULL signals and VOID signals are sent.

FIG. 11 is a detailed block diagram of the data-link receiving part and the data-link transmitting part of the interface part for a case where FULL signals and VOID signals are sent.

FIG. 12 is a block diagram of the data-link receiving part of the interface part for a first type of a method of avoiding overflow of the memories.

FIG. 13 is a detailed block diagram of the data-link receiving part of the interface part for a first type of a method of avoiding overflow of the memories.

FIG. 14 is a detailed block diagram of the data-link transmitting part of the control part for a first type of a method of avoiding overflow of the memories.

FIG. 15 is a block diagram of the data-link receiving part of the interface part for a second type of a method of avoiding overflow of the memories.

FIG. 16 is a timing chart showing a memory storage amount control operation.

FIG. 17 is a block diagram showing the communication apparatus in which error detection is performed at the data-link receiving part of the control part.

FIG. 18 is a block diagram showing the communication apparatus in which error detection is performed at the data-link receiving part of the interface part.

### DETAILED DESCRIPTION OF THE PREFERRED EMBODIMENTS

In the following, principles and embodiments of the present invention will be described with reference to the accompanying drawings.

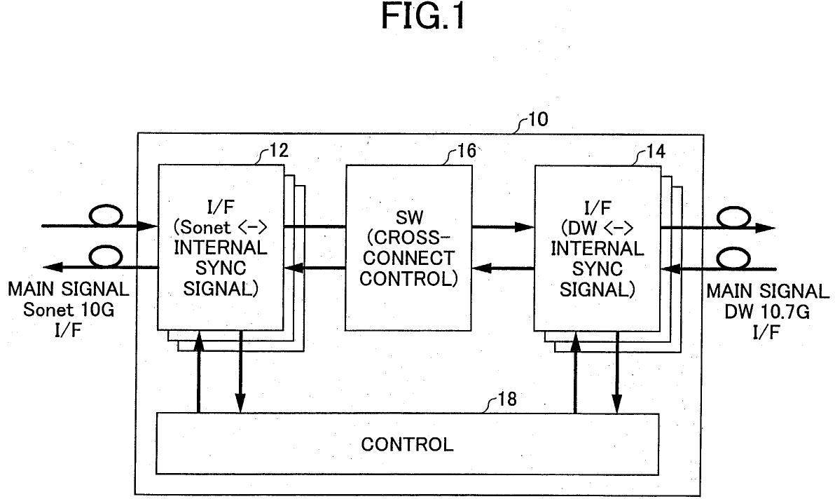

FIG. 1 is a block diagram showing a basic structure of an asynchronous transmission apparatus 10 of an embodiment of the present invention. The asynchronous transmission apparatus 10 conforms to a Sonet (synchronous Optical Network)/SDH (Synchronous Digital Hierarch) system, hereinafter referred to as “Sonet”, and to a Digital Wrapper system, hereinafter referred to as “DW”). The asynchronous transmission apparatus 10 includes a Sonet interface part 12, a DW interface part 14, a switch (SW) part 16 performing an exchange process of payloads of signals, and a control part 18 for performing a termination process and a control process of control information of the signals. As shown in FIG. 1, the asynchronous transmission apparatus 10 is capable of accommodating a plurality of Sonet interface parts 12 and a plurality of DW interface parts 14.

A flow of signals in the asynchronous transmission apparatus 10 will be described according to an example in which signals are input into the asynchronous transmission apparatus 10 from the Sonet side and are output from the DW side. The Sonet interface part 12 separates the input signal into payload and control information (overhead information) and sends the payload to the SW part 16 and the control information to the control part 18. The control part 18 performs a termination process and a control process of the control information. Then, the control part 18 sends the processed control signal to the DW interface part 14. The DW interface part 14 outputs the control information together with the switched payload out of the asynchronous transmission apparatus 10.

The interface parts 12, 14 and the control part 18 of the asynchronous transmission system 10 will be described in detail.

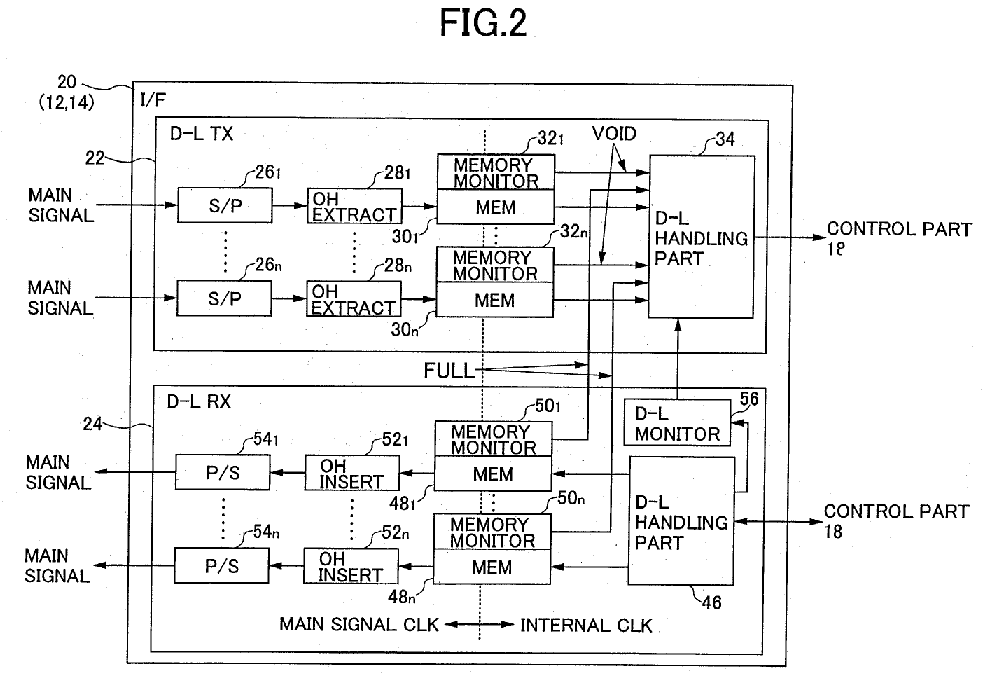

Structures of the interface parts 12, 14 will be described with reference to FIG. 2. It is to be noted that the interface parts 12, 14 have the same basic structure for both the Sonet system and the DW system, and therefore will be hereinafter referred to as an interface part 20.

The interface part 20 includes a data-link transmitting part 22 and a data-link receiving part 24. The data-link transmitting part 22 receives input signals from the network and transmits control information of the input signals to the control part 18. The data-link receiving part 24 receives the control information from the control part 18 and outputs output signals containing the control information from the control part 18 and the payload onto the network. The data-link transmitting part 22 and the data-link receiving part 24 are capable of inputting/outputting a plurality of signal as shown in FIG. 2.

The configuration of the data-link transmitting part 22 in the interface part 20 will be described in detail. The data-link transmitting part 22 is capable of receiving a plurality of input signals. The data-link transmitting part 22 is provided with n memory parts 30₁-30ₙ for storing control information contained in the input signals, serial/parallel conversion (S/P) parts 26₁-26ₙ for serial/parallel converting the input signals and over head (OH) extracting parts 28₁-28ₙ for extracting the control information, for respective one of the input signals, and a data-link handling part 34.

The memory parts 30₁-30ₙ are provided with memory monitoring parts 32₁-32ₙ, respectively, for monitoring a memory storage amount of each memory.

The data-link handling part 34 of the data-link transmitting part 22 will be described in detail. The data-link handling part 34 generates a frame 36 having a format that is common to a plurality of types of signals to send the control information stored in the memory parts 30₁-30ₙ to the control part 18.

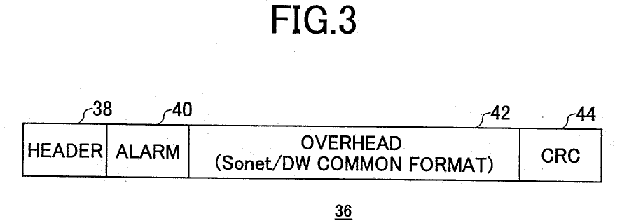

FIG. 3 shows a frame generated in the data-link handling part 34. The frame 36 includes a header part 38, an alarm information part 40, an overhead information part 42 and a CRC (Cyclic Redundant Code) part 44. The header part 38 may contain data such as a frame-synchronization byte and a toggle byte. The alarm information part 40 may contain data such as a FULL flag, a VOID flag and a data-link status flag. The overhead information part 42 may contain data such as control information. It is to be noted that the overhead information part 42 has a format common to a plurality of types of signals.

Referring again to FIG. 2, the configuration of the data-link receiving part 24 in the interface part 20 will be described in detail. The data-link receiving part 24 is capable of outputting a plurality of output signal. Accordingly, the data-link receiving part 24 is provided with n memory parts 48₁-48ₙ for storing control information contained in the output signals, P/S parts 54₁-54ₙ for parallel/serial (hereinafter, parallel/serial will be denoted as P/S) conversion to obtain output signals and over head (OH) extracting parts 52₁-52ₙ for extracting the control information, for respective one of the input signals, a data-link handling part 46 and a data-link status monitoring part 56.

The memory parts 48₁-48ₙ are provided with memory monitoring parts 50₁-50ₙ, respectively, for monitoring a memory storage amount of each memory.

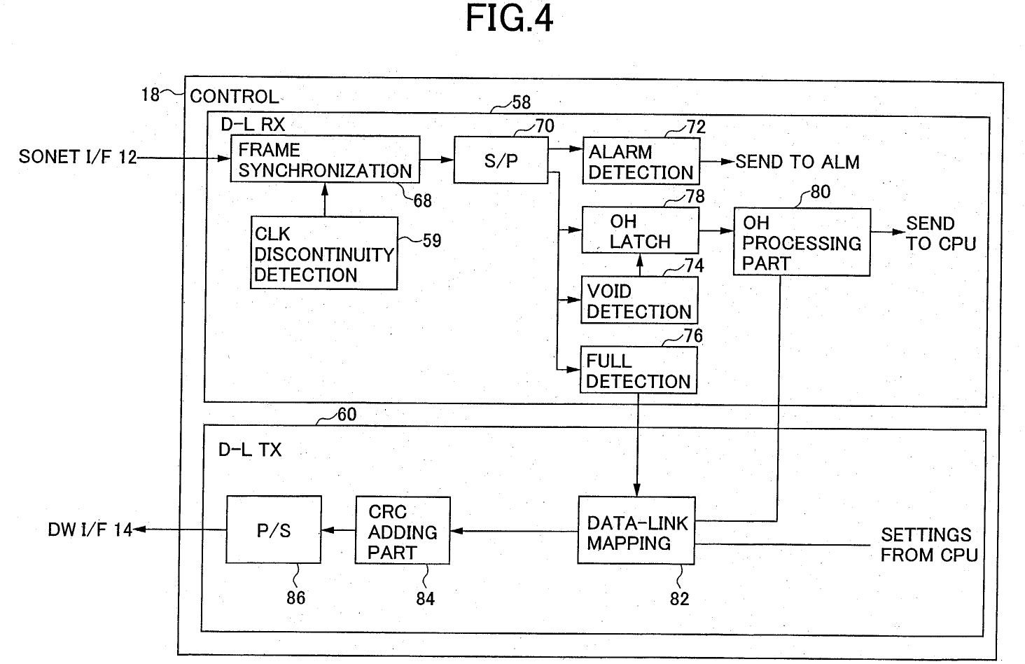

The control part 18 will be described in detail with reference to FIG. 4. The control part 18 includes a data-link receiving part 58 for receiving frames from the Sonet interface part 12 and a data-link transmitting part 60 for transmitting the processed frame to the DW interface part 14.

The configuration of the data-link receiving part 58 of the control part 18 will be described. The data-link receiving part 58 includes a CLK discontinuity detecting part 59 for detecting a discontinuity of serial link clocks, a frame synchronization part 68 for detecting frame patterns of the input signals, an serial/parallel (hereinafter denoted as “S/P”) conversion part 70 for serial/parallel converting the input signals, an alarm detecting part 72 for sending alarms, a VOID detecting part 74, a FULL detecting part 76 and an OH processing part 80 for processing the control information. The VOID detecting part 74 and the FULL detecting part 76 will be described later.

Now, the data-link transmitting part 60 of the control part 18 will be described in detail. The data link transmitting part 60 includes a data-link mapping part for performing data-mapping, a CRC adding part 84 for adding CRC to the frame and a P/S part 86 for P/S conversion of the frames.

The termination process and the control process of the control information will be described with an example in which for a communication apparatus including the interface part 20 and the control part 18, the signals are input into the communication apparatus from the Sonet side and output from the DW side.

The signals input into the Sonet interface part 12 are S/P converted in the S/P parts 26₁-26ₙ of the data-link transmitting part 22 shown in FIG. 2. Then, the signals are each separated into payload and control information in the over head (OH) extracting parts 28₁-28ₙ. The extracted control information is stored in the memory parts 30₁-30ₙ and is monitored by the memory monitoring parts 32₁-32ₙ. Then, the data-link handling part 34 assembles the control information stored in the memory parts 30₁-30ₙ into frames having a format shown in FIG. 3, and sends the frames to the control part 18.

In the asynchronous transmission apparatus of the present embodiment, various clocks are used as reference clocks for the above-described operations. Signal clocks of the input signals are used for operations between an input operation of signals into the apparatus and an operation of storing the signals into the memory parts 30₁-30ₙ. An internal reference clock of the apparatus that is selected as being faster than any of the signal clocks of the input signals is used for operations performed between the memory parts 30₁-30ₙ and the data-link handling part 34, and for operations performed in the control part 18.

Since various clocks are used as reference clocks, the data-link handling part 34 may receive incomplete control information that has not been completely stored in the memory parts 30₁-30ₙ and empty control information that has not at all been stored in the memory parts 30₁-30ₙ. Further, the data-link handling part 34 may assemble such invalid control information into frames and send such invalid frames to the control part 18. Therefore, there is a possibility that the control part 18 processes the invalid control information.

In order to avoid processing the invalid control information, the memory monitoring part 32₁-32ₙ send out VOID signals to inform that the control signals are invalid. For the sake of clarity, the following description is made for one of the signals that are input into the apparatus. In a first type of a method of avoiding processing of invalid data, a VOID signal is directly sent to the control part 18 and in a second type of a method of avoiding processing of invalid data, a VOID signal is sent to the data-link handling part 34.

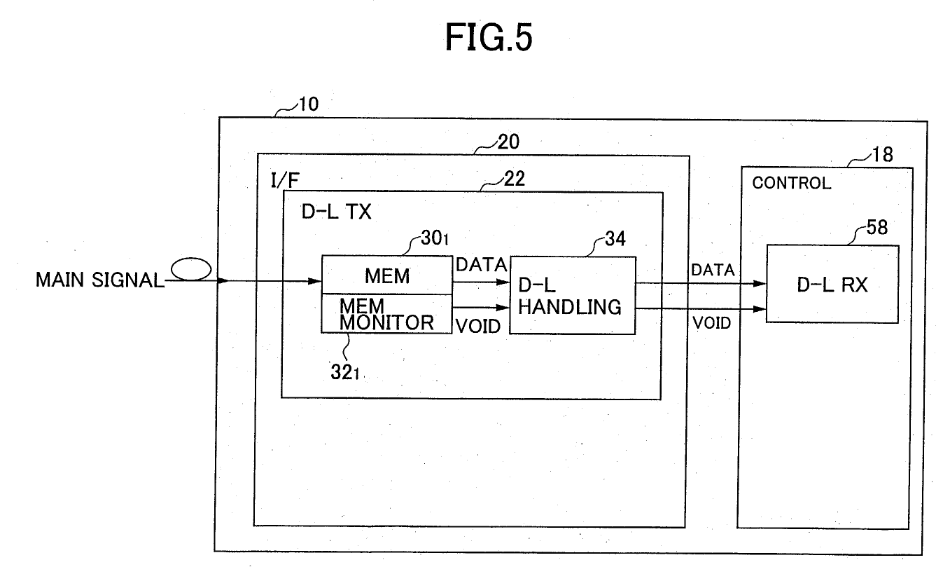

FIG. 5 is a diagram showing a configuration of the interface part 20 and the control part 18 for the first type of a method of avoiding processing of invalid data. FIG. 5 shows that the memory monitoring part (e.g., 32₁) sends a VOID signal that passes through the data-link handling part 34 and is received by the data-link receiving part 58.

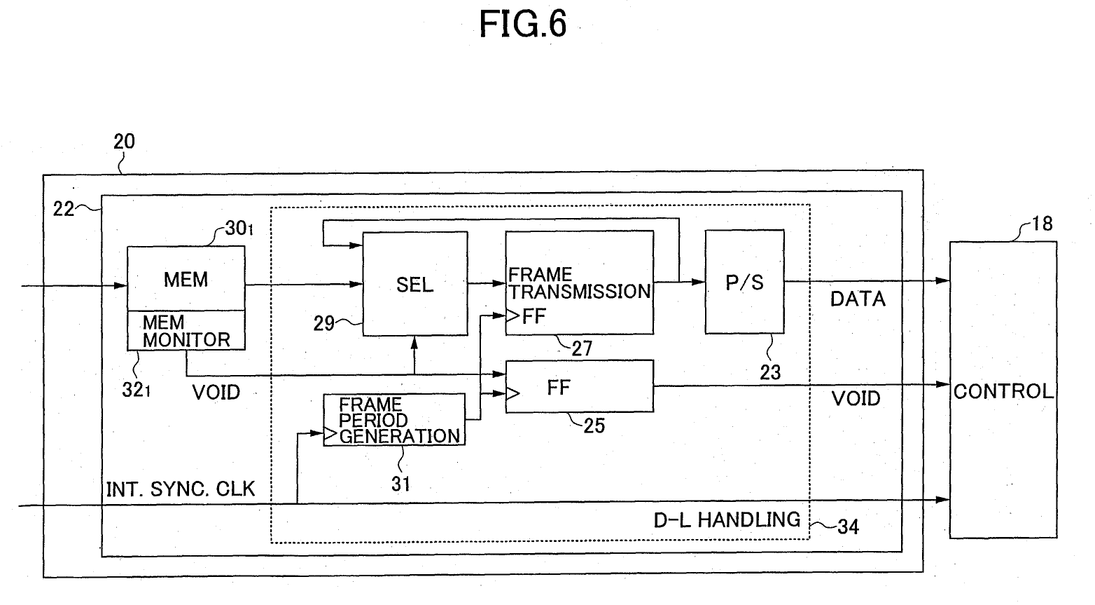

FIG. 6 is a detailed diagram of the data-link handling part 34 for a case shown in FIG. 5. The data-link handling part 34 includes a frame period generating part 31 for generating a period for assembling frames in response to an internal synchronization clock, a flip-flop circuit (hereinafter referred to as FF) 25, a selector 29, a frame transmission FF 27 and a P/S part 23.

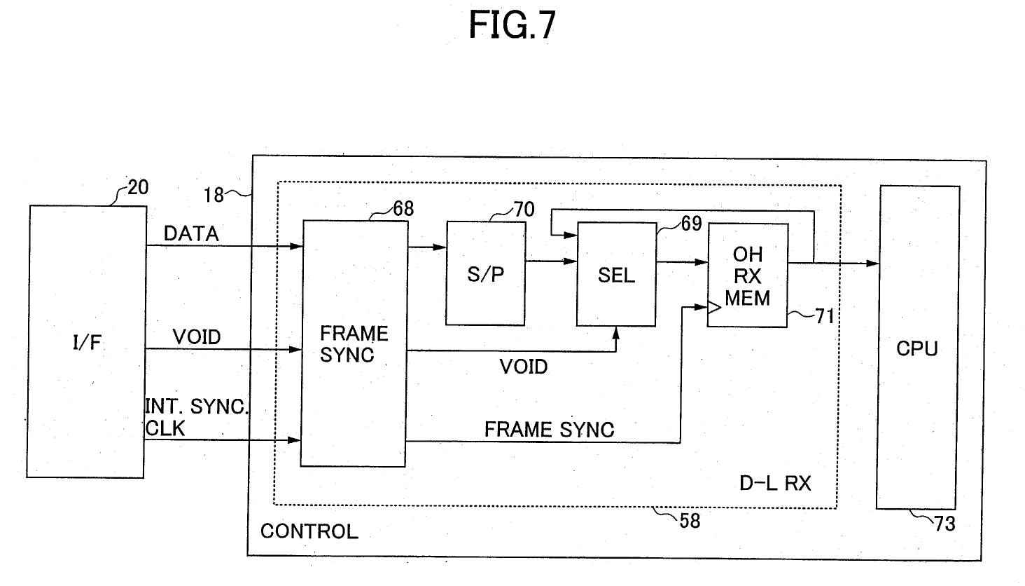

FIG. 7 is a detailed diagram of the data-link receiving part 58 in the control part 18. The data-link receiving part 58 includes a frame synchronization part 68, a selector 69, an S/P part 70 and an OH (Over Head) receiving memory part 71.

A flow of the VOID signal in the data-link handling part 34 of the interface part 20 and the data-link receiving part 58 in the control part 18 in the above-described structure will be described with reference to FIGS. 6 and 7. Referring first to FIG. 6, the VOID signal is sent from the memory monitoring part 32₁ to the FF 25 and to the selector 29. Further, the FF 25 passes the VOID signal to the control part 18.

Referring to FIG. 7, the VOID signal received by the control part 18 is sent to the frame synchronization part 68. After synchronization, the VOID signal is sent from the selector 69 to the OH receiving memory part 71. Upon reception of the synchronized VOID signal, the control part 18 discards the invalid frames corresponding to the VOID signals to avoid processing invalid frames.

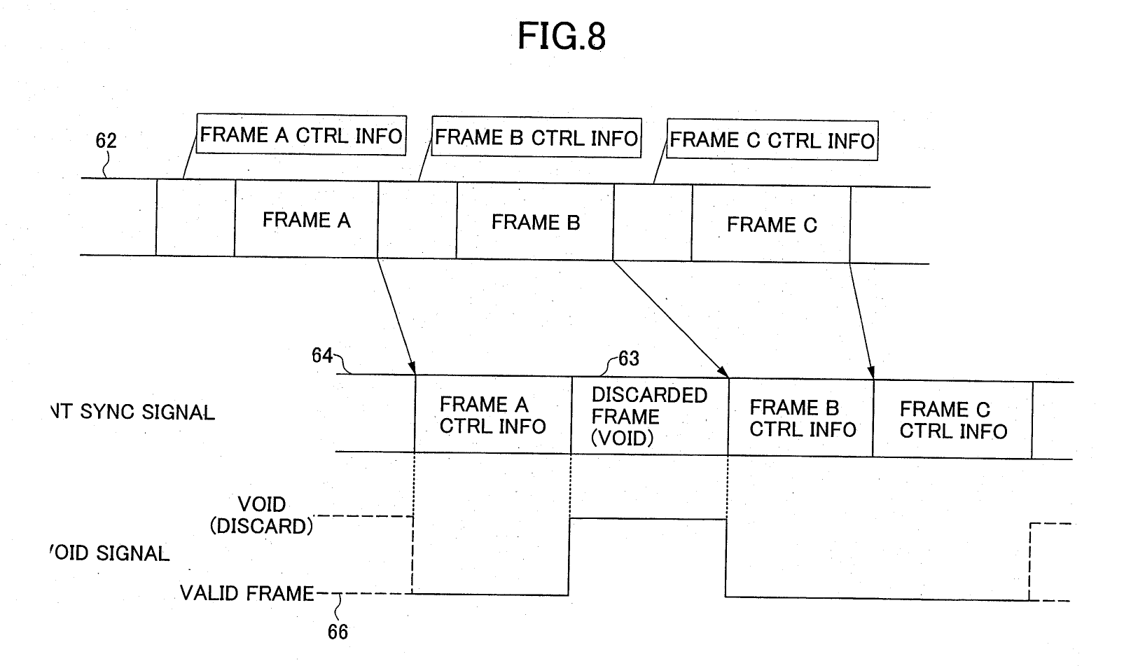

FIG. 8 is a timing chart of a VOID signal and frames showing how the invalid control information is discarded by the control part 18.

As can be seen in FIG. 8 and described in the above text, control information for frame A through frame C of an input signal 62 is stored in response to a timing of a signal clock of the input signal 62. However, other elements such as the data-link handling part 34 and the control part 18 operate in response to an internal synchronization signal 64 that is synchronized with the internal reference clock of the communication apparatus. Accordingly, as a result of using different clocks, valid control information cannot be inserted between the control information of frame A and the control information of frame B. Thus, a frame between the control information of frame A and the control information of frame B is a discarded frame 63.

In case of such invalid control information, the memory monitoring part 32₁ generates a VOID signal 66 that is synchronized with the internal reference clock and sends the VOID signal to the control part 18 to inform that it is an invalid frame. Then, the control part discards the invalid frames.

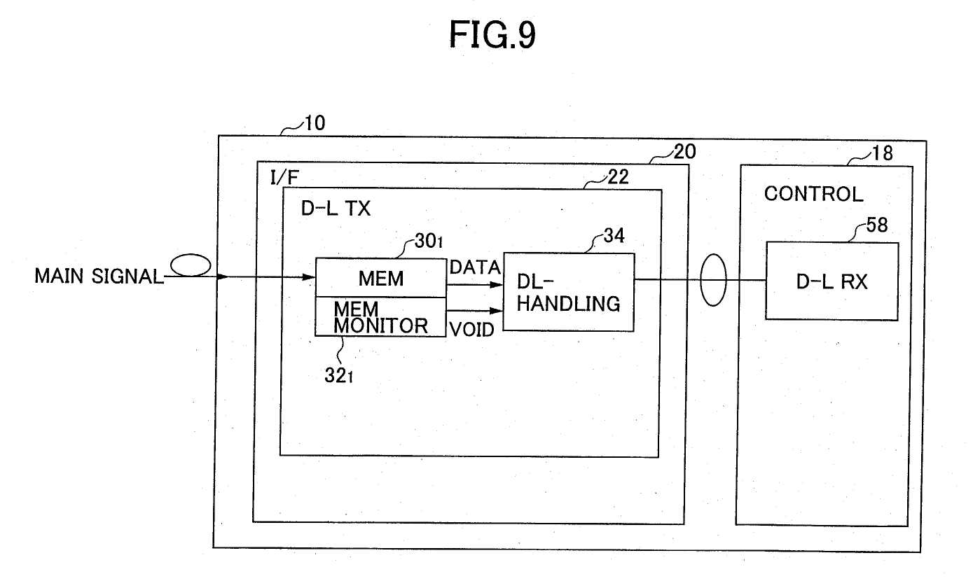

Referring to FIG. 9, a configuration of the interface part 20 and the control part 18 for the of a method of avoiding processing of invalid data will be described. FIG. 9 shows that the memory monitoring part (e.g., 32₁) sends a VOID signal to the data-link handling part 34 of the interface part 20 and a frame containing a VOID flag with the VOID flag being ON is transmitted from the data-link handling part 34 of the interface 20 to the control part 18.

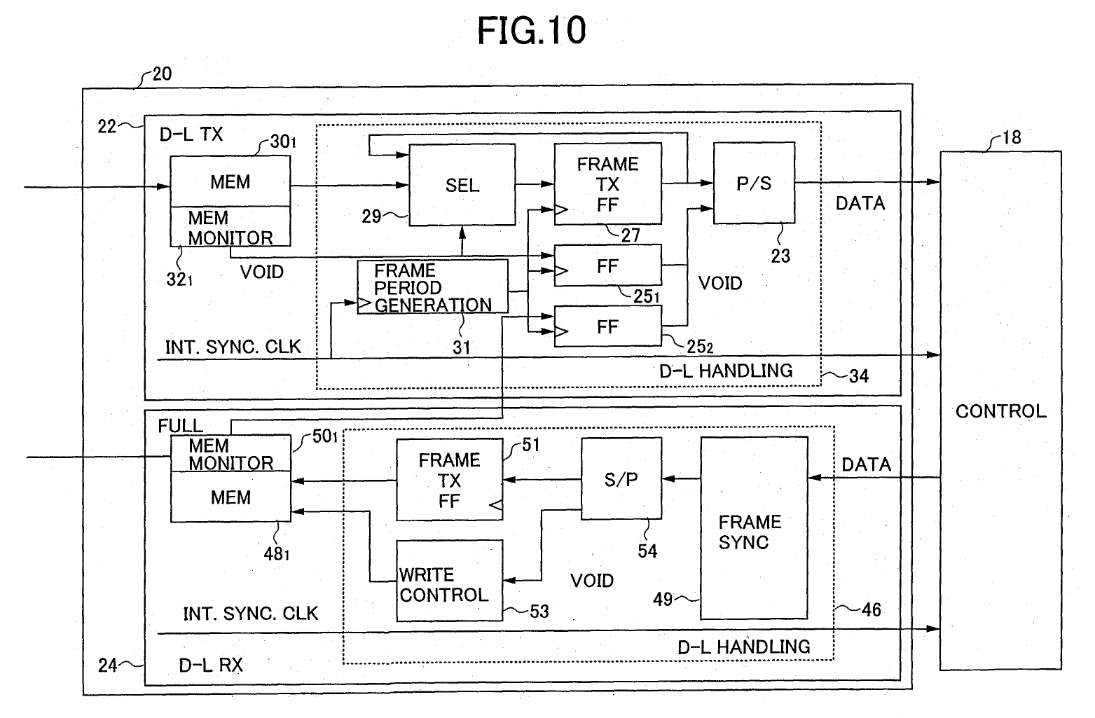

FIG. 10 is a detailed diagram of the data-link handling part 34 of the interface 20 for such a case where the VOID flag is contained in the frame. The data-link handling part 34 includes a frame period generating part 31 for generating a period of assembling frames in response to synchronization clocks, two FFs 25₁ and 25₂, a selector 29, a frame transmission FF 27 and a P/S part 23.

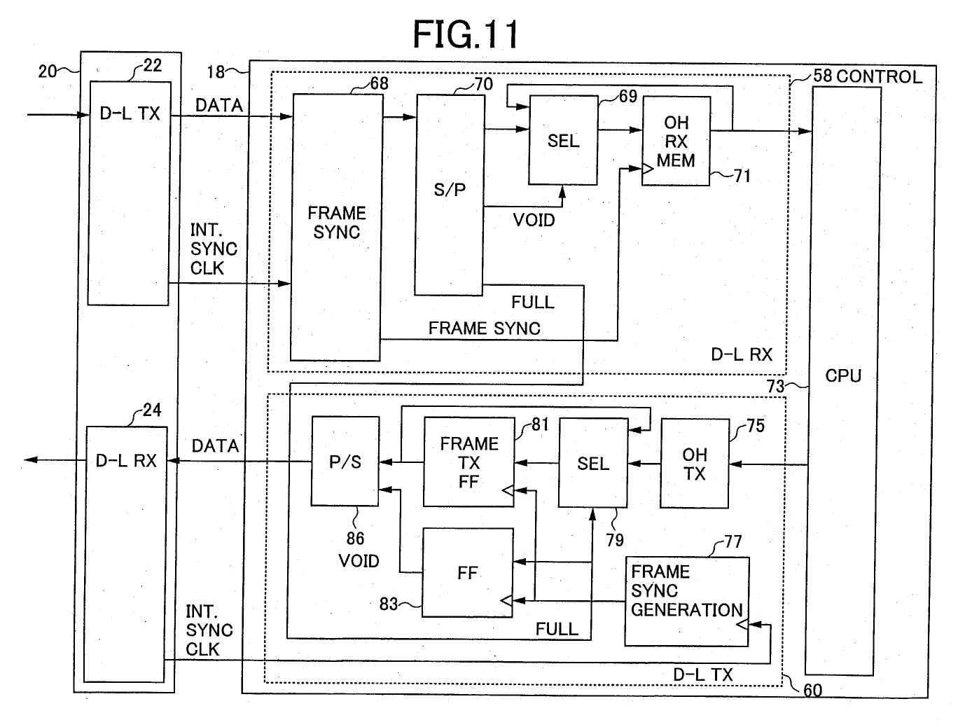

FIG. 11 is a detailed diagram of the data-link receiving part 58 in the control part 18. The data-link receiving part 58 includes a frame synchronization part 68, an S/P part 70, a selector 69 and an OH (Over Head) receiving memory part 71.

A flow of the VOID signal in the data-link handling part 34 and the control part 18 of such a configuration will be described with reference to FIGS. 10 and 11.

Referring first to FIG. 10, the VOID signal output from the memory monitoring part 32₁ is sent to the FF 25₁ and the selector 29. The frame transmission FF 27 sets the VOID flag that is provided in the alarm information part 40 (see FIG. 3) in the relevant frame to an ON state. The frame is P/S converted in the P/S part 23 and is output to the control part 18.

As shown in FIG. 11, the frames output from the control part 18 are received at the frame synchronization part 68, S/P converted in the S/P part 70, passed through the selector 69 and are output to the OH receiving memory 71. Thus, the control part 18 uses the VOID flag in the frame to determine whether that frame should be discarded or not, and if so, the control part 18 discards the relevant frame.

Therefore, when the VOID flag is provided in the frame sent from the data-link transmitting part 34 to the control part 18 as in the second type of a method of avoiding processing of invalid data, control signals of the interface part 20 and the control part 18 can be reduced. Therefore, according to the present invention, a transmission apparatus with an increased density can be provided.

Two types of a method of avoiding processing of invalid data due to different clocks have been described above.

In the following text, the control part 18 for performing a termination process and a control process of the frames will be described with reference to FIG. 4.

A frame received by the control part 18 is firstly input into the data-link receiving part 58. The data-link receiving part 58 detects a synchronization byte of the frame at the frame synchronization part 68, converts the frame in the S/P part 70 and refers to the alarm information part 40 of the frame at the alarm detecting part 72.

The VOID flag or a FULL flag that will be described later of the alarm information part 40 are detected at VOID flag detecting part 74 and the FULL flag detecting part 76, respectively. Also, a flag indicating data-link status is also defined in the alarm information part 40 in the frame. When the data-link status flag shows an abnormal state, the data-link receiving part 58 sends an alarm to a CPU part 73.

For a valid frame in which no abnormal state is indicated by the data-link status flag, the data-link receiving part 58 latches the control information at the OH latch 78. Then the VOID flag is ON, the control information is not OA latched. The control information of the valid frame is subjected to various termination processes at the OH processing part 80. The processed control information is transferred to the data-link transmitting part 60, if required.

At the data-link transmitting part 60, the control information to be transferred and the control information set by the CPU are mapped on the data in the frame at a data-link mapping part 82. A CRC is added to the control information at the CRC adding part 84. The frame that has been P/S converted at the P/S part 86 is output to the DW interface part 14.

The data-link handling part 46 of the interface part 20 will be described for a case where the frame is input thereto.

The frame from the control part 18 is transmitted to the data-link handling part 46 of the interface part 20 shown in FIG. 2. The data-link handling part 46 extracts the control information from the frames. The extracted control information is stored in the memory parts 48₁-48ₙ. The memory parts 48₁-48ₙ, are provided with memory monitoring parts 50₁-50ₙ, respectively, for monitoring a memory storage amount of each memory.

As has been described above, the control information is stored in response to the timings of the internal reference clock. It is to be noted that the internal reference clock is selected as being faster than any of the signal clocks of the input signals. Therefore, the memory parts 48₁-48ₙ may overflow since its data inflow rate is greater than data outflow rate.

In order to avoid an overflow of the memories, the memory monitoring parts 50₁-50ₙ send out FULL signals when the storage amount of control signals exceeds a predetermined threshold. The threshold is selected as a value that allows some storage capacity being left in the memory part for the frame that is received during a time period in which the FULL signal is sent to the data-link transmitting part, transferred to the control part and the frame with the flag reaches the data-link receiving part. For the sake of clarity, the following description is made for one of the signals that are input into the apparatus. In a first type of a method of avoiding overflow of the memories, FULL signals are sent to the control part 18 and in a second type a method of avoiding over flow of the memories, FULL signals are sent to the data-link handling part 34.

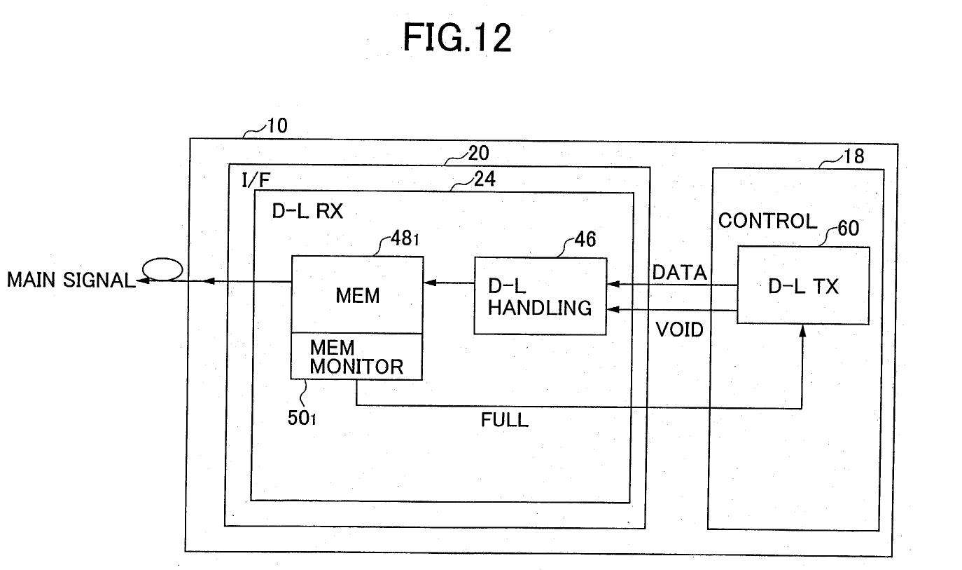

Referring to FIG. 12, a configuration of the interface part 20 and the control part 18 for the first type of a method of avoiding overflow of the memories will be described. FIG. 12 shows that the memory monitoring part (e.g., 50₁) sends a FULL signal directly to the data-link transmitting part 60 of the control part 18.

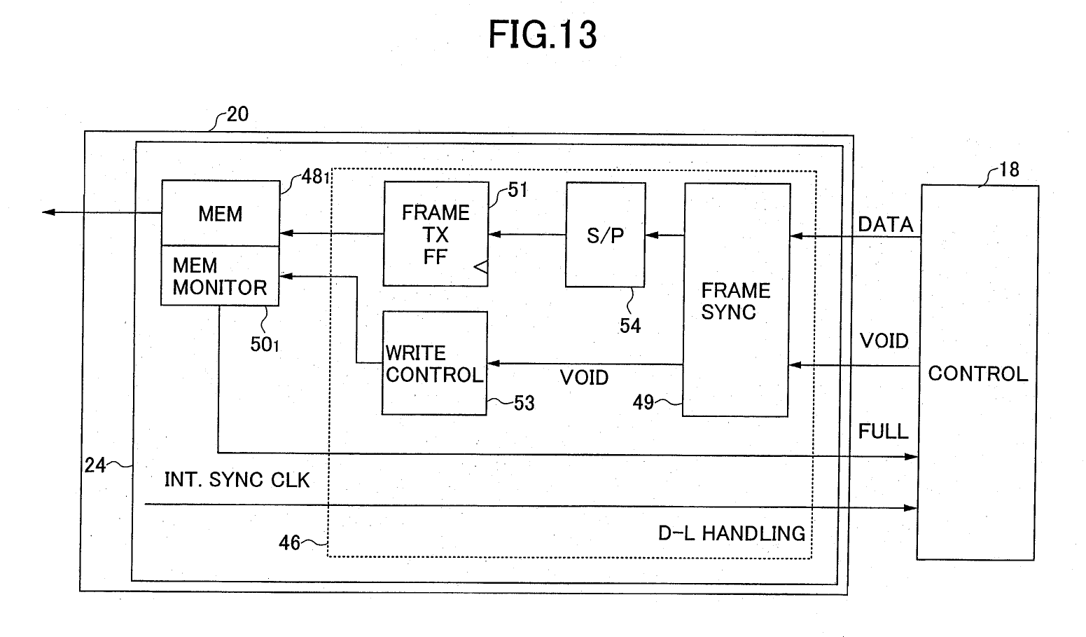

FIG. 13 is a detailed diagram of the data-link handling part 46 for such a case. The data-link handling part 46 includes a frame synchronization part 49, a frame reception FF 51, a writing control part 53 and an S/P part 54.

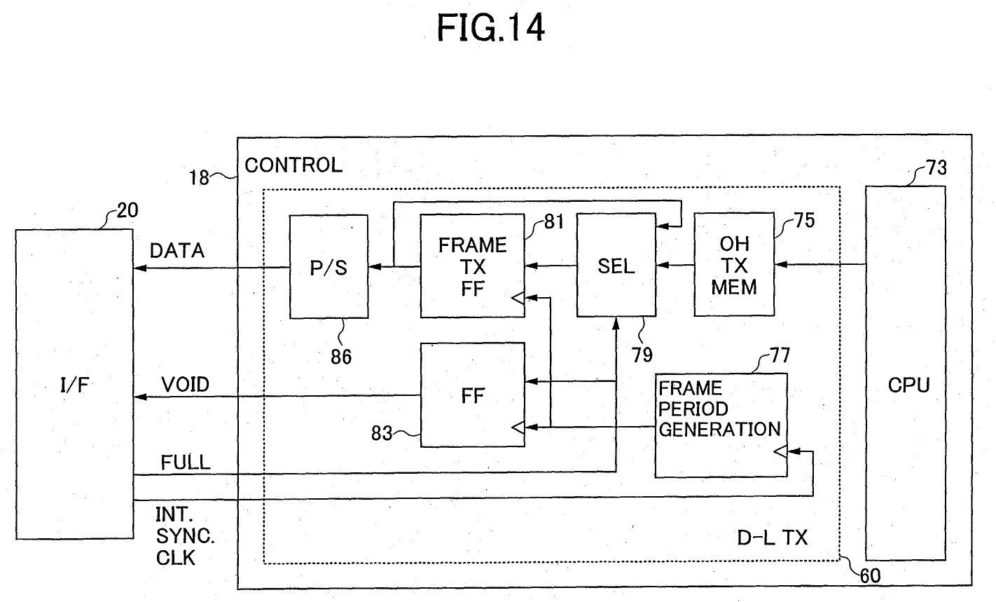

The data-link transmitting part 60 in the control part 18 shown in FIG. 14 includes an over head (OH) transmission memory part 75, a frame period generating part 77, a selector 79, a frame transmission FF 81, an FF 83 and a P/S part 86.

A flow of the FULL signal in the data-link transmitting part 60 and the control part 18 of such a configuration will be described with reference to FIGS. 13 and 14.

As can be seen in FIG. 13, when the memory storage amount of the memory part (e.g., 48₁) exceeds the predetermined threshold, the memory monitoring part 50₁ sends a FULL signal to the data-link transmitting part 60 in the control part. The data-link transmitting part 60 transmits an invalid frame to the data-link handling part 46 and sends the VOID signal from the FF 83 to the data-link handling part 46.

Upon reception of the invalid frame and the VOID signal, the data-link handling part 46 destroys the invalid frame and does not store it in the memory part 48₁. The control information that is already store in the memory part 48₁ is added to the payload and output to the network. Therefore, the memory storage amount will be reduced.

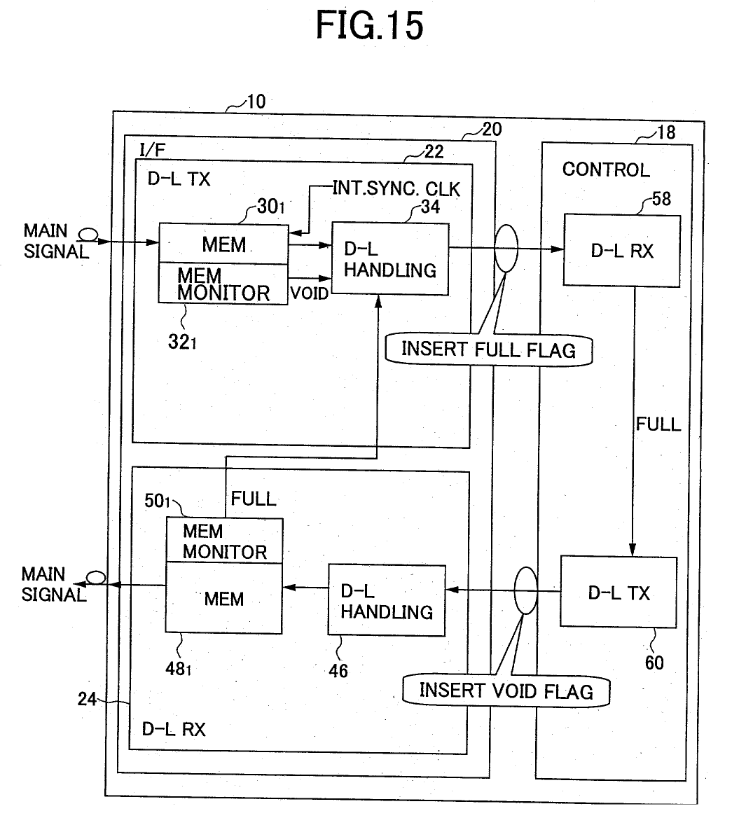

Referring to FIG. 15, a configuration of the interface part 20 and the control part 18 for the second type of a method of avoiding overflow of the memories will be described. FIG. 15 shows that the memory monitoring part (e.g., 50₁) sends a FULL signal directly to the data-link handling part 34 in the data-link transmitting part 22. FIG. 15 also shows that the frame containing the VOID flag with the VOID flag being ON is output from the data-link handling part 34 to the data-link receiving part 58 and also output from the data-link transmission part 60 to the data-link handling part 46.

FIG. 10 is a detailed diagram of the data-link handling part 46 for such a case. The data-link handling part 46 includes a frame synchronization part 49, a frame reception FF 51, a writing control part 53 and an S/P part 54.

The data-link transmitting part 60 in the control part 18 shown in FIG. 11 includes an OH (Over Head) transmission memory part 75, a frame period generating part 77, a selector 79, a frame transmission FF 81, an FF 83 and a P/S part 86.

A flow of the FULL signal in the data-link receiving part 24, the data-link handling part 34 and the control part 18 of such a configuration will be described with reference to FIGS. 10 and 11.

As can be seen in FIG. 10, when the memory storage amount of the memory part 48₁ exceeds the predetermined threshold, the memory monitoring part 50₁ sends a FULL signal to the FF 25₂ of the data-link transmitting part 34. The data-link transmitting part 34 transmits the frame containing a FULL flag with the FULL flag being ON to the control part 18.

Upon reception of the frame with the FULL flag being ON, the control part 18 sends a FULL signal from the S/P part 70 of the data-link receiving part 58 to the selector 79 of the data-link sending part 60, thereby sending the invalid frame having the VOID flag being ON to the data-link handling part 46.

Since the alarm information part contains the VOID flag that is ON, the data-link handling part 46 destroys the received frame and does not store it in the memory part 48₁. The control information that is already store in the memory part 48₁ is added to the payload and output to the network. Therefore, the memory storage amount will be reduced.

Therefore, when the FULL flag is contained in the frame sent from the data-link transmitting part 34 to the control part 18 as in the second type of a method of avoiding processing of invalid data, control signals sent between the interface part 20 and the control part 18 can be reduced. Therefore, according to the present invention, a transmission apparatus with an increased density can be provided.

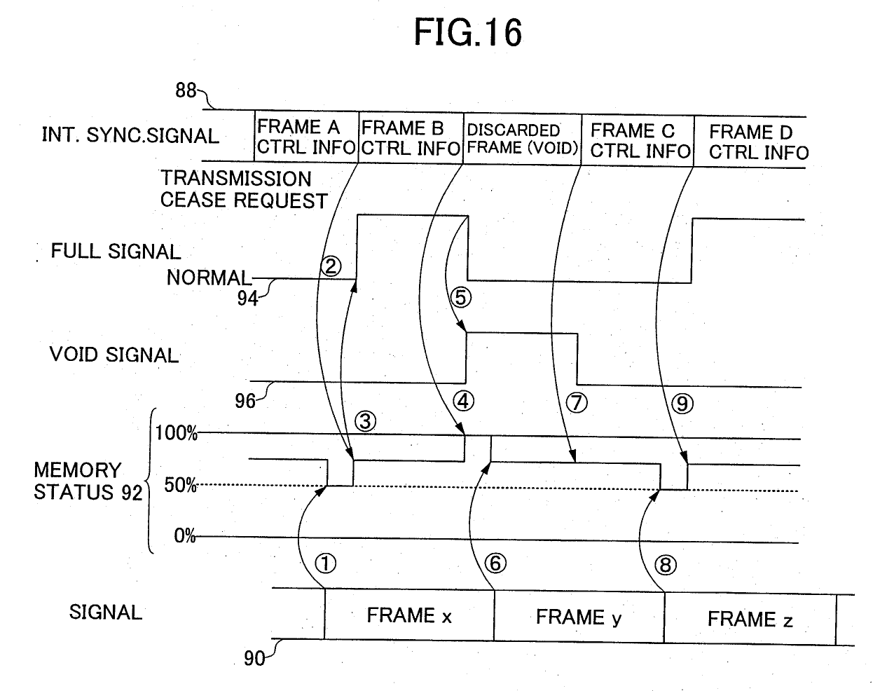

The above-described process will be described in detail with reference to FIG. 16. FIG. 16 is a timing chart of the FULL signal and the frames. In FIG. 16, an internal synchronization signal 88 is a frame that is transmitted to the data-link receiving part 24 and a signal 90 is a signal that is output to the network. A memory status 92 represents a storage rate in the memory part 48 and the higher levels of the FULL signal 94 and the VOID signal 96 that are shown by solid lines indicate that that signal is being sent. In this example, a threshold is determined as 75% of the total memory storage amount.

In an initial state shown in FIG. 16, the memory storage ratio is 75%. Arrow 1 shows that a frame x is transmitted to the network and the memory storage ratio is reduced to 50%. Arrow 2 shows that a frame A is received and the memory storage ratio is increased to 75%. Accordingly, the memory monitoring sends a FULL signal 94, as shown by an arrow 3. At an instant the FULL signal 94 is sent, the next frame B is transmitted and thus cannot take that FULL signal into account. Therefore, the frame that is to be transmitted subsequently is invalidated. Since the frame B is stored in the memory, an arrow 4 shows that the memory storage ratio is 100%. In this state, a frame y is transmitted to the network as shown by an arrow 6 and the data-link handling part can receive the invalid destroyed frame as shown by an arrow 7 and destroy the frame and avoid an overflow due to a storing operation of the frame by the VOID signal as shown by an arrow 5.

In the above description, it has been described that the input signals from the network are processed via the interface part, the control part and the interface part again and finally output to the network.

Now, a transmission error detection function for detecting-transmission errors will be described. In a first type of transmission error detection, the control part 18 detects errors for the frames from the interface part 20 and in a second type of transmission error detection, the data-link receiving part 24 detects errors in the communication status.

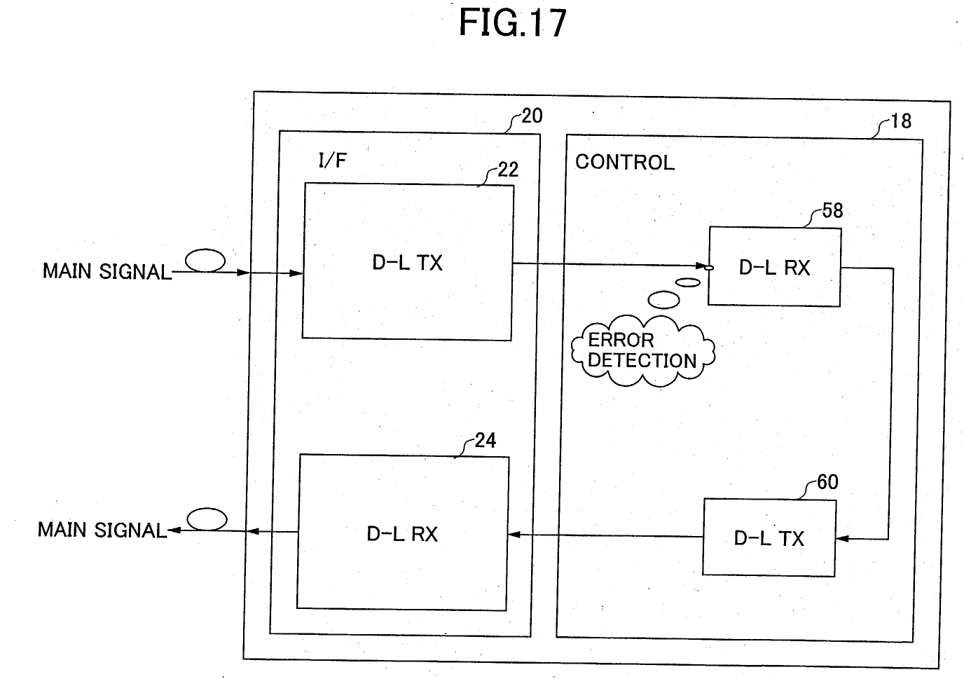

Referring to FIG. 17, the first type of transmission error detection will be described. As has been described with reference to FIG. 3, the flag indicating the data-link status in communication is defined in the frame. The data-link receiving part 58 refers to the data-link status flag in the frame transmitted from the data-transmitting part 22. If an error is detected, the data-link transmitting part 60 initializes the memory for storing frames to be transmitted to the data-link receiving part 24 to invalidate the transmission frames that are to be sent to the data-link receiving part 24. Such a configuration can be implemented on a hardware and thus can reduce processes to be performed by a software and can increase the processing speed.

When an error is detected, the data-link receiving part operates as follows. The error detecting function is performed on the data-link status monitoring part 56 shown in FIG. 2. However, if the control part 18 and the interface part 20 are constructed as separate units, communication statuses of the separate units are, for example, monitored by a unit receiving the data and the information is sent only within that unit.

Therefore, if the control part 18 and the interface part 20 are constructed as separate units, there is a need to provided connection means such as a CPU bus to the interface part 20 and to detect communication errors via the CPU bus.

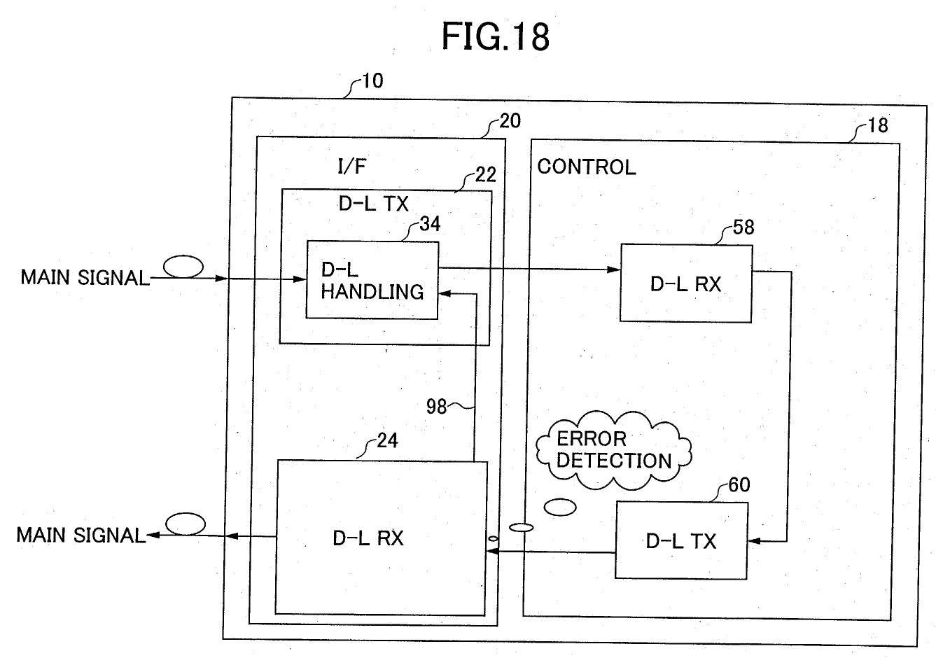

Accordingly, as shown in FIG. 18, a data-link error informing path 98 is provided for informing about the error from the data-link receiving part 24 to the data-link handling part 34.

With such a configuration, the data-link handling part 34 can take the error into account for the data-link status in the frame and inform about it to the control part 18. Accordingly, the control part 18 can monitor errors without using the bus. Therefore, the configuration of the transmission apparatus can be simplified.

Further, the present invention is not limited to these embodiments, and variations and modifications may be made without departing from the scope of the present invention.

The present application is based on Japanese priority application No.2001-267732 filed on Sep. 4, 2001, the entire contents of which are hereby incorporated by reference.

What is claimed is:

1. A communication apparatus for interfacing various types of signals with different bit-rates, comprising:
a receiving part receiving input signals, generating frames of a predetermined common format containing control information of said input signals and determining whether said frames are valid; and
a control part receiving said frames from said receiving part and performing a predetermined internal process based on the result of the determination.

2. The communication apparatus as claimed in claim 1, wherein said frames are transferred from said receiving part to said control part in synchronous with a predetermined reference clock.

3. The communication apparatus as claimed in claim 2, wherein said predetermined reference clock is an internal synchronization clock of said transmission apparatus that is faster than signal clocks of said input signals.

4. The communication apparatus as claimed in claim 1, wherein said control part performs error detection on said frames and performs said predetermined internal process for erroneous frames.

5. The communication apparatus as claimed in claim 4, wherein said error detection is achieved by hardware.

6. The communication apparatus as claimed in claim 4, wherein said predetermined internal process includes invalidating said frames determined as being invalid.

7. The communication apparatus as claimed in claim 1, wherein said receiving part includes:
memory parts storing said control information contained in said input signals; and
assembling parts reading out said control information from said memory parts and assembling said control information into frames of a common format.

8. The communication apparatus as claimed in claim 7, wherein said assembling part reads out said control information from said memory parts, and
said memory parts send first instruction signals to said assembling parts, said first instruction signals indicating whether said control information is valid or not.

9. The communication apparatus as claimed in claim 7, wherein said frames contain first instruction information that takes a predetermined value in accordance with said first instruction signal, and
said control part performs said predetermined process based on said first instruction information.

10. The communication apparatus as claimed in claim 7, wherein said control part reads said frames from said receiving part, and
said memory parts send first instruction signals to said control part said first instruction signals indicating whether said frame is valid or not.

11. The communication apparatus as claimed in claim 10, wherein said control part performs said predetermined internal process based on said first instruction signals from said memory part.

12. The communication apparatus as claimed in claim 9, wherein said predetermined process includes discarding invalid frames.

13. The communication apparatus as claimed in claim 1, further comprising a transmitting part receiving said frames from said control part, extracting said control information from said frames and transmitting output signals of different bit-rates.

14. The communication apparatus as claimed in claim 1, wherein said transmitting part includes:
memory parts storing said control information extracted from said frames, said control information being written into said memory parts in synchronous with said predetermined reference clock and said control information being read out from said memory parts in synchronous with signal clocks of each of said input signals.

15. The communication apparatus as claimed in claim 1, wherein said transmitting part performs error detection and informs of a presence of any error to said receiving part and said receiving part informs of said error to said control part.

16. The communication apparatus as claimed in claim 1, wherein said transmitting part includes memory parts storing said extracted control information and sending second instruction signals to said control part based on storage status of the memory part, said second instruction signal being a request for ceasing an output operation of valid frames.

17. The communication apparatus as claimed in claim 1, wherein said control part performs a predetermined internal process on said frame based on said second instruction signal and sends the frame to said transmitting part,
said transmitting part performs a predetermined process based on said second instruction signal.

18. The communication apparatus as claimed in claim 1, wherein said transmitting part includes memory parts storing said extracted control information, said transmitting part sending second instruction signals to said control part based on storage status of the memory part, said second instruction signal being a request for ceasing an output operation of valid frames.

19. The communication apparatus as claimed in claim 1, wherein said receiving part sends said frame assembled in-accordance with said second signal to said control part,
said control part performs a predetermined internal process based on said frame and sends frames to said transmitting part,
said transmitting part performing a predetermined process based on said signal.

20. The communication apparatus as claimed in claim 17, wherein said predetermined internal process includes buffering said frames and generating invalidated frames, and
said predetermined process further includes discarding said invalidated frames.

21. A communication apparatus for interfacing various types of signals with different bit-rates, comprising:
a receiving part receiving input signals, generating frames of a predetermined common format containing control information of said input signals and determining whether said frames are valid;
a control part receiving said frames from said receiving part and performing a predetermined internal process based on the result of the determination; and
a transmitting part extracting said processed control information from said frames and transmitting output signals of different bit-rates.
